(19) United States
(12) Patent Application Publication
(10) Pub. No.: US 2024/0329894 A1
(43) Pub. Date: Oct. 3, 2024

(54) PRINTING APPARATUS, PRINTING METHOD, AND INFORMATION PROCESSING APPARATUS

(71) Applicant: Sharp Kabushiki Kaisha, Sakai City (JP)

(72) Inventor: YOSHITAKA OGATA, Sakai City (JP)

(21) Appl. No.: 18/591,219

(22) Filed: Feb. 29, 2024

(30) Foreign Application Priority Data
Mar. 28, 2023 (JP) 2023-051962

(51) Int. Cl. G06F 3/12

(52) U.S. Cl. CPC G06F 3/1228; G06F 3/1205

(57) ABSTRACT

A printing apparatus includes: a printing section that is capable of printing a print job based on Internet Printing Protocol; and a controller that performs a print setting by reflecting a first attribute value being not defined by the Internet Printing Protocol when it is determined that specific Internet Printing Protocol attribute information is included in the received print job, performs a print setting by reflecting a second attribute value being defined by the Internet Printing Protocol when it is determined that the specific Internet Printing Protocol attribute information is not included in the received print job, and controls the printing section, based on the set print setting.

### CROSS-REFERENCE TO RELATED APPLICATION

The present application claims priority from Japanese Application JP 2023-051962, the content to which is hereby incorporated by reference into this application.

### BACKGROUND OF THE INVENTION

### 1. Field of the Invention

The present disclosure relates to a printing apparatus and the like.

### 2. Description of the Related Art

A printer driver supplied by a vendor that provides a printing apparatus is configured in such a way that a capability of the printing apparatus can be exhibited to the maximum extent. However, the printer driver supplied by the vendor needs to be individually introduced by a user who uses the printing apparatus. Therefore, for example, for a user who has difficulty in acquiring a printer driver because a network environment or the like is not developed, it is difficult to introduce the printer driver supplied by the vendor.

On the other hand, a standard printer driver incorporated in an operating system (OS) in advance does not need to be individually introduced by a user who uses a printing apparatus. However, available functions are limited to standard functions in order to cope with various printing apparatuses.

In consideration of such a situation, in recent years, efforts are being made to sufficiently utilize the capability of the printing apparatus by introducing an application for supporting the printing (hereinafter, referred to as a print support application) even when printing is performed using a standard printer driver.

### SUMMARY OF THE INVENTION

An object of the present disclosure is to provide a printing apparatus and the like that are capable of correctly exhibiting a capability of the printing apparatus to be targeted by a print support application in a print job related to a combination of a standard printer driver and the print support application.

In order to solve the above problem, a printing apparatus according to the present disclosure includes: a printing section that is capable of printing a print job based on Internet Printing Protocol; and a controller that performs, when it is determined that specific Internet Printing Protocol attribute information is included in the received print job, a print setting by reflecting a first attribute value that is not defined by the Internet Printing Protocol, that performs, when it is determined that the specific Internet Printing Protocol attribute information is not included in the received print job, a print setting by reflecting a second attribute value that is defined by the Internet Printing Protocol, and that controls the printing section, based on the set print setting.

In addition, a printing method according to the present disclosure is a method of printing a print job, based on Internet Printing Protocol, and the printing method includes: performing, when it is determined that specific Internet Printing Protocol attribute information is included in the received print job, a print setting by reflecting a first attribute value that is not defined by the Internet Printing Protocol; performing, when it is determined that the received print job does not include the specific Internet Printing Protocol attribute information, a print setting by reflecting a second attribute value that is defined by the Internet Printing Protocol; and executing the print job, based on the set print setting.

Furthermore, an information processing apparatus according to the present disclosure includes: a storage that stores a control program and a print support program; and a controller that is capable of generating a print job based on Internet Printing Protocol by executing the control program, wherein the controller functions as a print support application by executing the print support program, and the print support application assigns specific Internet Printing Protocol attribute information indicating that the print job is a print job to be output via the print support application.

According to the present disclosure, it is possible to provide a printing apparatus and the like that are capable of correctly exhibiting a capability of the printing apparatus to be targeted by a print support application in a print job related to a combination of a standard printer driver and the print support application.

### BRIEF DESCRIPTION OF THE DRAWINGS

FIG. 1 is a diagram illustrating an example of a connection form of a multifunction peripheral according to an embodiment.

FIG. 2 is a functional configuration diagram of the multifunction peripheral according to the embodiment.

FIG. 3 is a functional configuration diagram of a terminal apparatus according to the embodiment.

FIG. 4 is a sequence diagram illustrating print processing by a single standard printer driver.

FIG. 5 is a sequence diagram illustrating print processing using a standard printer driver and a print support program.

FIG. 6 is a sequence diagram illustrating print processing according to the embodiment.

FIG. 7 is a diagram illustrating an example of Internet Printing Protocol attribute information of Job-Attributes.

FIG. 8 is a flowchart illustrating a flow of processing of the multifunction peripheral according to the embodiment.

FIG. 9 is a flowchart illustrating a flow of processing of the terminal apparatus according to the embodiment.

FIG. 10 is a diagram illustrating an operation example when a standard printer driver is used.

FIG. 11 is a diagram illustrating an operation example according to the embodiment.

FIG. 12 is a diagram illustrating another example of Internet Printing Protocol attribute information of Job-Attributes.

### DETAILED DESCRIPTION OF THE INVENTION

An embodiment of the present disclosure will be explained below with reference to the drawings. The following embodiment is an example for explaining the present disclosure, and the technical content of the explanation described in the claims is not limited to the following description.

An information processing apparatus generates a print job via a printer driver installed in an operating system (OS) or a standard printer driver provided as a standard function of the OS when a printing apparatus such as a multifunction peripheral is controlled to process the print job. In general, a printer driver to be installed and used in an OS is provided for each printing apparatus by a vendor of the printing apparatus, and is configured in such a way that a capability of the printing apparatus can be sufficiently exhibited (hereinafter, the printer driver may be referred to as a dedicated printer driver).

On the other hand, in many cases, the standard printer driver only supports a function common to each printing apparatus in order to provide versatility that enables printing with many (various) printing apparatuses.

In recent years, even in a case of processing a print job using a standard printer driver, the same print result as in a case of using a dedicated printer driver has been increasingly demanded. In addition, in order to improve stability and security of the OS, efforts are being made by vendors who provide the OS to extend the function of the standard printer driver.

As an aspect of the above-described approach, a print support application that supports processing of a print job by the standard printer driver is known. The print support application is generally provided as an application by a vendor or the like that provides an OS or a printing apparatus. The print support application is driven together with the standard printer driver and configured in such a way that the function of the printing apparatus can be sufficiently exhibited based on acquired capability information of the printing apparatus.

Such a print support application can convert a Page Description Language (PDL) and add a Print Job Language (PJL) command to a print job based on the standard printer driver.

Internet Printing Protocol (hereinafter, simply referred to as IPP) is known as a communication protocol for transmitting and receiving a print job and necessary information between an information processing apparatus and a printing apparatus. In the IPP, the print job is expressed by document data in a predetermined PDL format (hereinafter referred to as PDL data) and IPP attribute information (hereinafter referred to as IPP Attributes). Herein, the IPP Attributes are, for example, attributes and their values (attribute values) that define the print settings and apparatus settings of the printing apparatus, an output capability of the printing apparatus (the number of copies, the finishing form, the printing quantity, and the like), and the like, in addition to definitions relating to printer operations such as “Print-job (print execution)” and “Get-Printer-Attributes (printer attribute acquisition)” and definitions relating to job operations such as “Get-Job-Attributes (job status acquisition)” and “Cancel-job (job cancellation)”. The printing apparatus can process the print job by analyzing the attribute value defined in the IPP Attributes.

The standard printer driver manages print settings related to a print job by using a print ticket (a collection of print-related attribute information and attribute values for acquiring a user's intention for a specific print job). Therefore, for example, when a PJL command common among vendors of the respective printing apparatuses is added to a print job by the print support application, the OS (standard printer driver) automatically generates IPP Attributes corresponding to the PJL command. However, since IPP Attributes is processed in preference to the PJL command depending on the printing apparatus, when the same function is designated for IPP Attributes and PJL, a vendor-specific PJL command may not be reflected in the processing of the print job.

Therefore, there is a need for a mechanism for acquiring a correct print result when a PJL command is added by a print support application without affecting other services that process a print job, based on the IPP standard.

In the present disclosure, the following embodiment achieves a printing apparatus that is capable of correctly exhibiting the capability of the printing apparatus to be targeted by the print support application, in a print job related to a combination of a standard printer driver and a print support application.

### 1 Embodiment

### 1.1 Overall Configuration

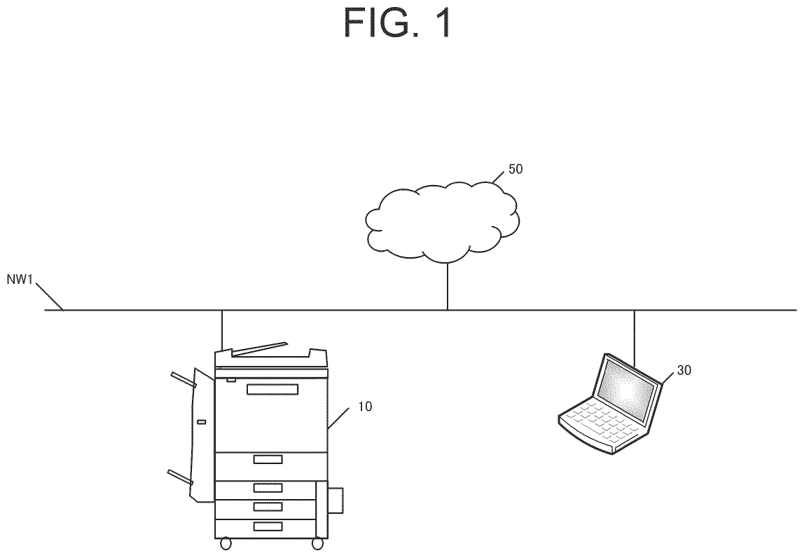

FIG. 1 is a diagram illustrating an example of a connection form of a multifunction peripheral 10 as a printing apparatus, a terminal apparatus 30 as an information processing apparatus, and a service 50 according to the present embodiment.

The multifunction peripheral 10 according to the present embodiment is a printing apparatus capable of achieving jobs such as printing, copying, faxing, and image transmission in a single housing. In the present disclosure, the multifunction peripheral 10 will be explained as one form of the printing apparatus, but the form is not particularly limited, and the printing apparatus may be a copying machine, a printer, a facsimile, or the like other than the multifunction peripheral 10.

The multifunction peripheral 10 is connected to the terminal apparatus 30 and the service 50 via a network NW1. The multifunction peripheral 10 can perform communication between the terminal apparatus 30 and the service 50 by using a communication protocol such as a hypertext transfer protocol (HTTP). The network NW1 represents a network line such as a local area network (LAN), a wide area network (WAN), or the Internet. The terminal apparatus 30 and the service 50 may be connected to another network other than the network NW1.

The terminal apparatus 30 is an information processing apparatus that is capable of outputting a print job to the multifunction peripheral 10. As the terminal apparatus 30, for example, a so-called general mobile terminal apparatus such as a smartphone, a tablet, a mobile phone, or a notebook computer is assumed, but the terminal apparatus 30 is not limited thereto. An installation-type terminal apparatus such as a desktop personal computer can also be included in the terminal apparatus of the present disclosure as long as it is in an environment in which it can communicate with the multifunction peripheral 10 and the service 50. In the present disclosure, the terminal apparatus 30 is configured in such a way that a print job can be generated via a printer driver installed in the OS or a standard printer driver provided as a standard function of the OS.

The service 50 can be configured as a service server capable of providing a print support application in response to a request for acquisition from the terminal apparatus 30 or the like. The terminal apparatus 30 can utilize the function of the print support application by installing a print support application downloaded from the service 50.

### 1.2 Functional Configuration

### 1. 2. 1 Regarding Multifunction Peripheral 10

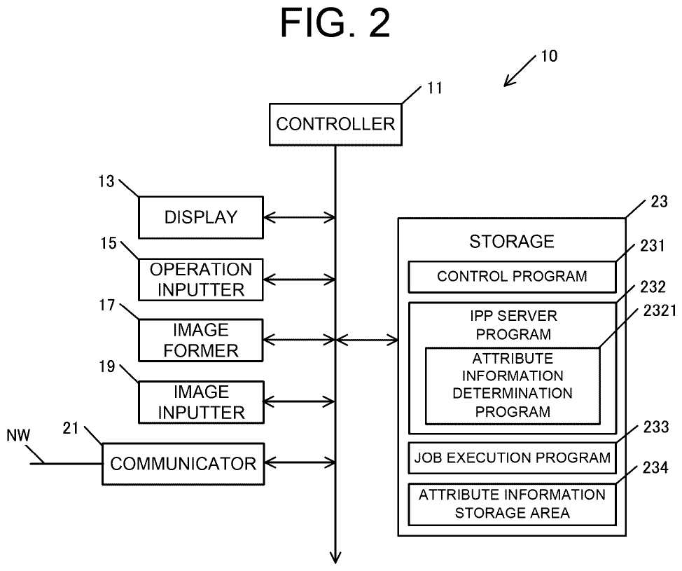

A functional configuration of the multifunction peripheral 10 according to the present embodiment will be explained. FIG. 2 is a functional configuration diagram of the multifunction peripheral 10. The multifunction peripheral 10 includes a controller 11, a display 13, an operation inputter 15, an image former 17, an image inputter 19, a communicator 21, and a storage 23.

The controller 11 controls the multifunction peripheral 10 as a whole. The controller 11 includes, for example, one or a plurality of arithmetic devices (such as central processing units (CPUs)). The controller 11 achieves functions thereof by reading and executing various programs stored in the storage 23.

The display 13 displays various kinds of information to a user or the like. The display 13 may be configured by, for example, a liquid crystal display (LCD), an organic electro-luminescence (EL) display, or the like.

The operation inputter 15 accepts an input of information by the user or the like. The operation inputter 15 may be configured by, for example, various input devices such as operation keys such as hard keys and software keys, and buttons. Note that the operation inputter 15 can be configured as a touch panel that enables input via the display 13. In such a case, as an input method of the touch panel, a general method such as a resistive film method, an infrared method, an electromagnetic induction method, or a capacitance method can be adopted, for example.

The image former 17 feeds a sheet from a sheet feed tray not to be illustrated, forms an image based on document data included in a print job, and then discharges the sheet to a sheet discharger not to be illustrated. The image former 17 can be configured by, for example, a laser printer or the like that uses an electrophotographic method. In this case, the image former forms an image by using a toner supplied from toner cartridges, which are not illustrated, corresponding to toner colors (for example, cyan, magenta, yellow, and black).

The image inputter 19 generates document data by scanning a document. The image inputter 19 includes, for example, an image sensor such as a charge coupled device (CCD) or a contact image sensor (CID), and can be configured as a scanner device having an automatic document feeder (ADF), a flatbed for placing and reading a document, or the like. The configuration of the image inputter 19 is not particularly limited as long as it can generate image data by reading a reflected light image from a document image with an image sensor. The image inputter 19 may be configured as an interface capable of acquiring document data, which are stored in a portable storage medium such as a universal serial bus (USB) memory, or a print job transmitted from the terminal apparatus 30.

The communicator 21 includes, for example, one or both of a wired interface and a wireless interface for communicating with other apparatuses (the terminal apparatus 30 and the service 50) via a network NW such as a LAN, a WAN, the Internet, a telephone line, or a facsimile line. The communicator 21 may include, for example, an interface relating to a (short-range) wireless communication technique such as Bluetooth (registered trademark), near field communication (NFC), Wi-Fi (registered trademark), ZigBee (registered trademark), Irda, or wireless USB.

The storage 23 stores various programs and various data necessary for the operation of the multifunction peripheral 10. The storage 23 can be configured by, for example, a storage device such as a random access memory (RAM), a hard disk drive (HDD), a solid state drive (SSD), and a read only memory (ROM).

In the present embodiment, the storage 23 stores a control program 231, an IPP server program 232, and a job execution program 233, and secures an attribute information storage area 234.

The control program 231 is a program that is read by the controller 11 when the multifunction peripheral 10 is controlled in an integrated manner. The controller 11 that has read the control program 231 controls driving of the display 13, the operation inputter 15, the image former 17, the image inputter 19, the communicator 21, and the like.

The IPP server program 232 is a program read by the controller 11 when a print job is exchanged with the terminal apparatus 30 as a client device, based on IPP. The controller 11 that has read the IPP server program 232 acquires a response to a search by the terminal apparatus 30, a response to a request for acquisition of capability information, or a print job transmitted from the terminal apparatus 30.

Furthermore, the IPP server program 232 includes an attribute information determination program 2321. The controller 11 that has read the attribute information determination program 2321 determines whether or not the received print job includes specific IPP Attributes in a Job-Attributes, which will be described later. The specific IPP Attributes is attribute information for identifying whether or not the received print job is a print job generated via the print support application.

The job execution program 233 is a program read by the controller 11 when a job such as printing, copying, faxing, or image transmission is executed. When the specific IPP Attributes is included in the received print job, the controller 11 that has read the job execution program 233 performs a print setting by reflecting a vendor-specific PJL command that is not defined by IPP as a first attribute value. On the other hand, when the specific IPP Attributes is not included in the received print job, the controller 11 performs a print setting by reflecting an attribute value defined by the IPP as a second attribute value.

The attribute information storage area 234 is a storage area for storing IPP Attributes related to the IPP.

### 1.2.2 Regarding Terminal Apparatus 30

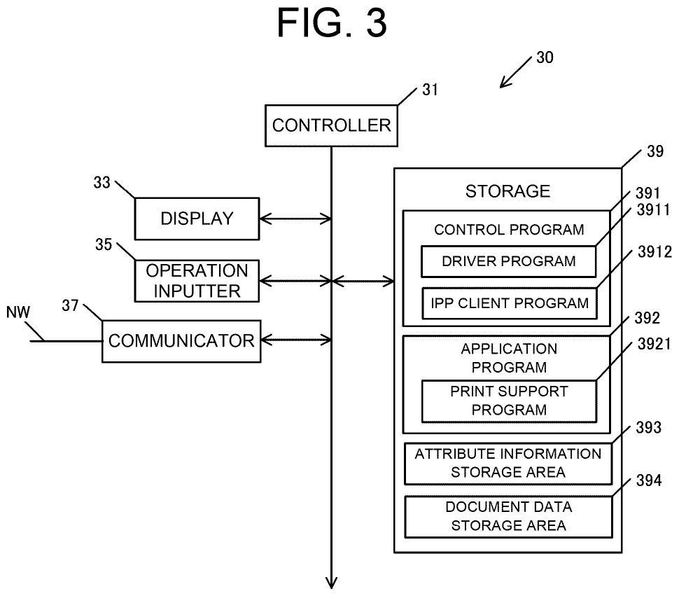

FIG. 3 is a functional configuration diagram of a terminal apparatus 30 according to the present embodiment. The terminal apparatus 30 includes a controller 31, a display 33, an operation inputter 35, a communicator 37, and a storage 39.

The controller 31 controls the terminal apparatus 30 as a whole. The controller 31 is configured by, for example, one or a plurality of arithmetic devices (such as CPUs). The controller 31 exhibits functions thereof by reading and executing various programs stored in the storage 39.

The display 33 displays various kinds of information to a user or the like. The display 33 can be configured by, for example, a display device such as an LCD or an organic EL display.

The operation inputter 35 accepts an input of information by the user or the like. The operation inputter 35 can be configured by various input devices such as a keyboard including hard keys, software keys, and the like, a mouse, a trackball, a touch pad, and a touch panel.

The communicator 37 includes one or both of a wired interface and a wireless interface for communicating with other apparatuses (the multifunction peripheral 10 and the service 50) via the network (NW) such as a LAN, a WAN, the Internet, a telephone line, and a facsimile line. In addition, the communicator 37 may include, for example, an interface relating to a (short-range) wireless communication technique such as Bluetooth (Registered trademark), NFC, Wi-Fi (Registered trademark), ZigBee (Registered trademark), Irda, or a wireless USB.

The storage 39 stores various programs and various data necessary for the operation of the terminal apparatus 30. The storage 23 can be configured by a storage device such as a RAM, an HDD, an SSD, or a ROM.

In the present embodiment, the storage 39 stores a control program 391 and an application program 392, and secures an attribute information storage area 393 and a document data storage area 394.

The control program 391 is an OS that is read by the controller 31 when the terminal apparatus 30 is controlled in an integrated manner. The controller 31 that has read the control program 391 performs driving of the display 33, the operation inputter 35, the communicator 37, and the like, activation and termination of an application operating on the OS, file management, and the like.

The control program 391 includes a driver program 3911 and an IPP client program 3912. The driver program 3911 is a standard printer driver that operates on the OS. The IPP client program 3912 is a program read by the controller 31 when a print job is exchanged with the multifunction peripheral 10, based on the IPP. The controller 31 that has read the IPP client program 3912 transmits a search for the multifunction peripheral 10, a request for acquisition of capability information, or a generated print job to the multifunction peripheral 10.

The application program 392 is a program read by the controller 31 in response to an activation instruction from the user. The controller 31 that has read the application program 392 provides a specific function according to purposes of the user, such as document creation, graphic drawing, and Internet browsing. The application program 392 can be acquired by installation using a recording medium such as a CD or a DVD, or by downloading from the service 50.

The application program 392 includes a print support program 3921. The print support program 3921 is a program that functions as a print support application by being read by the controller 31, and that improves and enhances the quality of a print result in cooperation with the standard printer driver. The print support program 3921 is supplied by a vendor of the OS or the printing apparatus, and the print support program can be introduced by downloading from the service 50 to be described later.

The attribute information storage area 393 is a storage area for storing IPP Attributes related to the IPP. The document data storage area 394 is a storage area for storing, for example, document data and the like that are created by document creation, graphic depiction, or the like.

### 1.2.3 Regarding Service 50

The service 50 according to the present embodiment can use a known configuration as long as the application program 392 (print support program 3921) can be provided in response to an acquisition request from the terminal apparatus 30 or the multifunction peripheral 10. Therefore, an explanation relating to the functional configuration of the service 50 will be omitted.

### 1.3 Flow of Processing 1.3.1 Flow of Overall Processing

Next, a flow of overall processing according to the present embodiment will be explained. Before explaining the flow of the processing according to the present embodiment, printing processing by a single standard printer driver (standard printing) and printing processing using the standard printer driver and the print support program, i.e., printing processing in which the print support program is associated with the standard printer driver will be explained, and then the print processing according to the present embodiment will be explained.

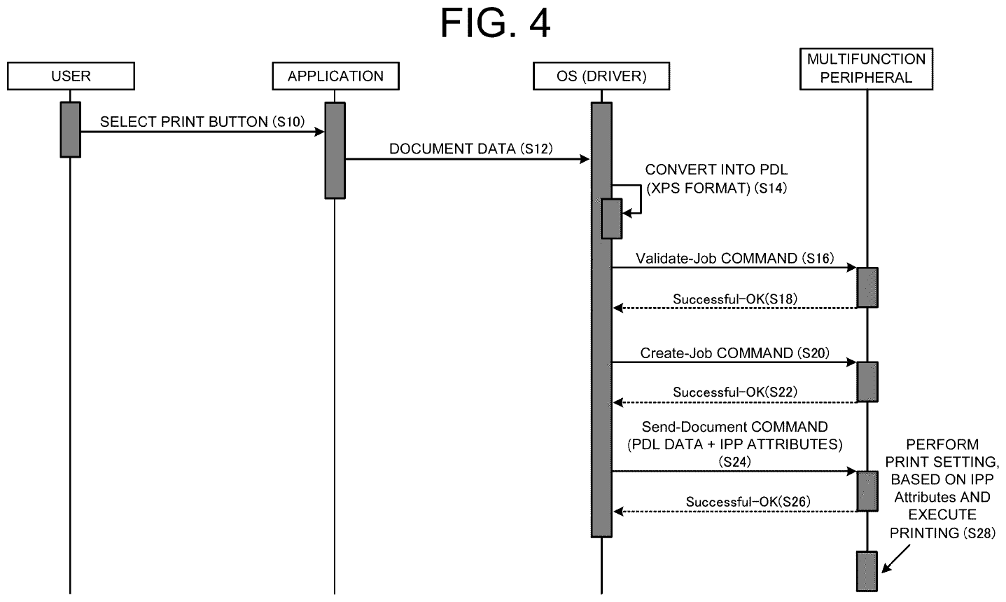

FIG. 4 is a sequence diagram illustrating print processing by a single standard printer driver. First, a user selects a print button provided in a print dialog of an application such as document creation or graphic drawing in order to print a document, a graphic, or the like, which is created with the application (S10).

When the print button is selected, the application passes document data corresponding to the created document, graphic, or the like to an OS (driver) (S12).

The OS (driver) converts the document data into PDL data (for example, XPS format) (S14). Then, the OS (driver) transmits a Validate-Job command for confirming validity of a job to the multifunction peripheral 10 (S16).

When the Validate-Job command is received, the multifunction peripheral 10 transmits a status command of Successful-OK to the OS (driver) in accordance with the validity of the job (S18).

When the Successful-OK status command is received, the OS (driver) transmits a Create-Job command instructing job generation to the multifunction peripheral 10 (S20).

When the Create-Job command is received, the multifunction peripheral 10 transmits a status command of Successful-OK to the OS (driver) in accordance with the reception status of the job generation (S22).

When the Successful-OK status command is received, the OS (driver) transmits the PD L data and IPP Attributes related to the document data converted in S14 to the multifunction peripheral 10 by a Send-Document command (S24).

When the Send-Document command is received, the multifunction peripheral 10 transmits a Successful-OK status command indicating that the PDL data and IPP Attributes have been accepted to the OS (driver) (S26). Then, the multifunction peripheral 10 performs a print setting based on the IPP Attributes, and executes printing (S28).

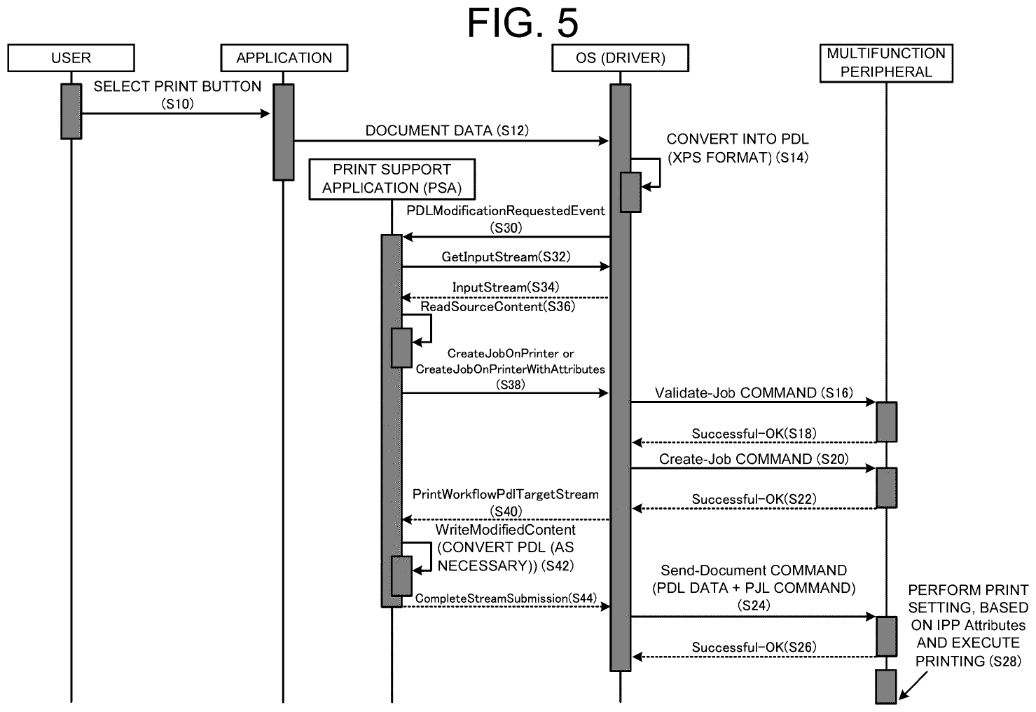

FIG. 5 is a sequence diagram illustrating print processing using the standard printer driver and the print support program. The same components as those explained with reference to FIG. 4 are denoted by the same reference numerals, and the explanation thereof will be omitted.

The OS (driver) converts the document data into PDL data (for example, XPS format) (S14), and then executes PDLModificationRequestEvent of the print support application (PSA) (S30).

The print support application (PSA) requests the OS (driver) to acquire PDL data (XPS format) (S32).

The OS (driver) that has received a request for acquisition of the PDL data (XPS format) passes the PDL data (XPS format) to the print support application (PSA) (S34).

The print support application (PSA) reads the acquired PDL data (XPS format) (S36), and requests the OS (driver) to generate a print job to be executed on the multifunction peripheral 10 or a print job with IPP Attributes (S38).

When the Successful-OK status command is received from the multifunction peripheral 10 (S22), the OS (driver) passes a stream for printout to the print support application (PSA) (S40).

The print support application (PSA) that has acquired the stream for outputting the print job converts the PDL (XPS format) acquired in S34 into a predetermined PDL in a PDF format, a PCL6 format, or the like as necessary (S42).

The print support application (PSA) flows PDL data (PDL data after conversion in a case of being converted into a predetermined PDL format) and a PJL command into a print-out stream acquired in S40, and notifies the OS (driver) of completion (S44).

The OS (driver) transmits the acquired PDL data and PJL command to the multifunction peripheral 10 by the Send-Document command (S24).

When the Send-Document command is received, the multifunction peripheral 10 transmits a Successful-OK status command indicating that the PDL data and IPP Attributes have been accepted to the OS (driver) (S26). In this case, depending on the multifunction peripheral 10, the print setting may be performed by giving priority to the IPP Attributes over the PJL command, and the printing may be executed (S28).

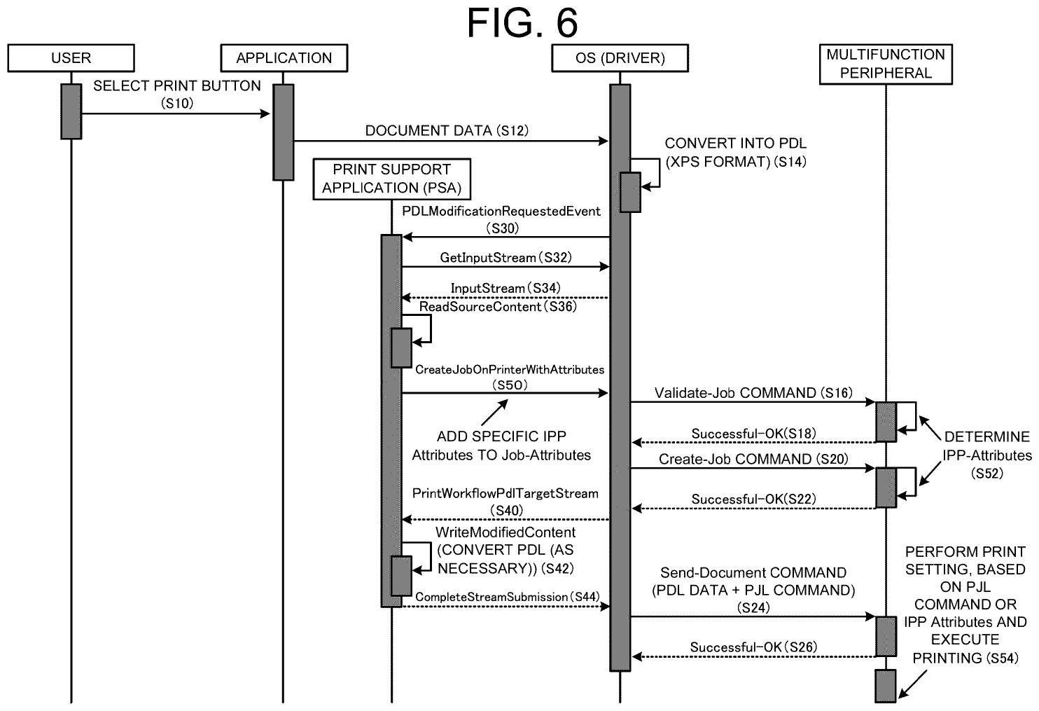

FIG. 6 is a sequence diagram illustrating a print processing according to the present embodiment. The same components as those explained in FIGS. 4 and 5 are denoted by the same reference numerals, and the explanation thereof will be omitted.

In the sequence diagram illustrated in FIG. 6, S38 in FIG. 5 is replaced with S50, and S28 is replaced with S54. In S50, the print support application (PSA) requests generation of a print job in which specific IPP Attributes are added to Job-Attributes (S50). The specific IPP Attributes is attribute information for determining whether the print job related to the generation request is based on the print support application (PSA) provided by the vendor.

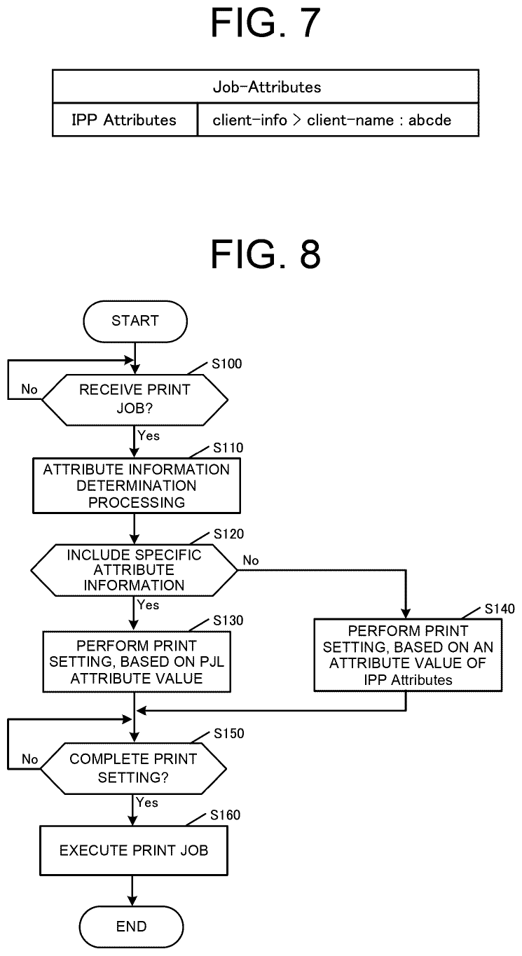

For example, FIG. 7 is a diagram illustrating an example of the specific IPP Attributes. FIG. 7 illustrates “client-info>client-name:abcde” as a specific IPP Attributes. Herein, “abcde” is unique identification information representing a name of the vendor or the like. The “client-info” may be, for example, a nickname, an ID, or the like other than names, and is not particularly limited as long as the information allows the multifunction peripheral 10 to uniquely identify the vendor.

When a request to generate a print job to which a specific IPP Attributes is added is received, the OS (driver) sends the IPP Attributes of the print job scheduled to be transmitted to the multifunction peripheral 10 by each of the Vadidate-Job command (S16) and the Create-Job command (S20).

The multifunction peripheral 10 determines whether or not “client-info>client-name:abcde” is included in the acquired IPP Attributes (S52).

When the Send-Document command sent in S24 is acquired, the multifunction peripheral 10 transmits a Successful-OK status command indicating that the PDL data and IPP Attributes have been accepted to the OS (driver) (S26). Then, when the specific IPP Attributes “client-info” is included in the print job, the multifunction peripheral 10 performs a print setting based on the PJL command and executes the print job. On the other hand, when the specific IPP Attributes “client-info” is not included in the print job, the print setting based on the IPP Attributes is performed, and the print job is executed (S54).

### 1.3.2 Flow of Processing of Multifunction Peripheral 10

Next, a flow of processing of the multifunction peripheral 10 will be explained with reference to a flowchart of FIG. 8. The processing to be explained with reference to FIG. 8 is executed by the controller 11 of the multifunction peripheral 10 reading the control program 231, the IPP server program 232, the job execution program 233, and the like.

The controller 11 determines whether or not a print job has been received from the OS (driver) (step S100). When it is determined that the print job has been received, the controller 11 performs attribute information determination processing (step S100; Yes→step S110). When it is determined that the print job is not received, the controller 11 waits until the print job is received (step S100; No).

When the controller 11 determines that “client-info>client-name:abcde” is included in the IPP Attributes as the specific attribute information in the Validate-Job command and the Creat-Job command explained in FIG. 6, the controller 11 performs the print setting, based on the vendor-specific PJL (step S120; Yes→step S130).

On the other hand, when it is determined that “client-info>client-name:abcde” is not included in the IPP Attributes as the specific attribute information in the Validator-Job command and the Creat-Job command, the controller 11 performs print setting, based on the IPP Attributes (step S120; No→step S140).

Then, the controller 11 determines whether or not the print setting is completed (step S150). When it is determined that the print setting is completed, the controller 11 executes the print job based on the set print setting and ends the processing (step S150; Yes→step S160). When the print setting is not completed, the controller 11 continuously performs the print setting (step S150; No).

### 1.3.3 Flow of Processing of Terminal Apparatus 30

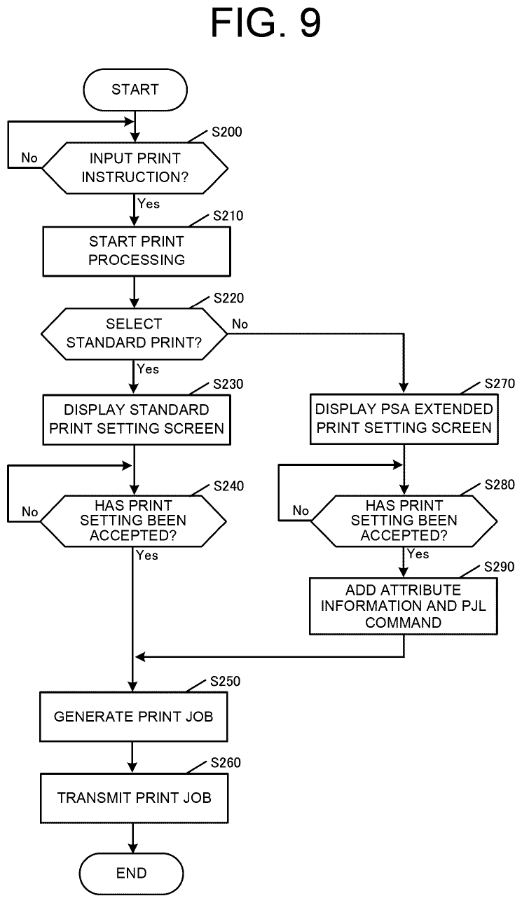

Next, a flow of processing of the terminal apparatus 30 will be explained with reference to a flowchart of FIG. 9. The processing to be explained in FIG. 9 is processing to be executed by the controller 31 of the terminal apparatus 30 reading the control program 391, the application program 392, and the like.

The controller 31 determines whether or not an input of a print instruction has been accepted through a print dialog or the like of the application (step S200). When it is determined that the input of the print instruction has been accepted, the controller 31 starts the print processing (step S200; Yes→step S210). When it is determined that the input of the print instruction is not accepted, the controller 31 waits until the print instruction is input (step S200; No).

The controller 31 that has started the print processing determines whether or not the print instruction is a print instruction related to standard printing (step S220). It is assumed that the print instruction related to standard printing is a print instruction via a single standard printer driver, and refers to a print instruction in a case where the print support program (PSA) is not associated with the standard printer driver. When it is determined that the received print instruction is the print instruction related to the standard printing, i.e., when it is determined that the received print instruction is the print instruction using a single standard printer driver, the controller 31 displays a standard print setting screen (step S220; Yes→step S230).

Then, the controller 31 determines whether or not the print setting via the standard print setting screen is completed (step S240). When it is determined that the print setting via the standard print setting screen is completed, the controller 31 generates a print job related to the standard printing (step S240; Yes→step S250). Then, the controller 31 transmits the generated print job to the multifunction peripheral 10, and ends the processing (step S260). When it is determined that the print setting via the standard print setting screen is not completed, the controller 31 continues the processing until the print setting is completed (step S240; No).

When it is determined that the print instruction accepted in step S200 is not the print instruction related to the standard printing, i.e., is the print instruction in a case where the print support program (PSA) is associated with the standard printer driver, the controller 31 displays the PSA extended print setting screen (step S220; No→step S270).

Then, the controller 31 determines whether or not the print setting via the PSA extended print setting screen is completed (step S280). When it is determined that the print setting via the PSA extended print setting screen is completed, the controller 31 adds specific IPP Attributes and a PJL command (step S290) and generates a print job (step S250). Then, the controller 31 transmits the generated print job to the multifunction peripheral 10, and ends the processing (step S260). When it is determined that the print setting via the PSA extended print setting screen is not completed, the controller 31 continues the processing until the print setting is completed (step S280; No).

### 1.4 Operation Example

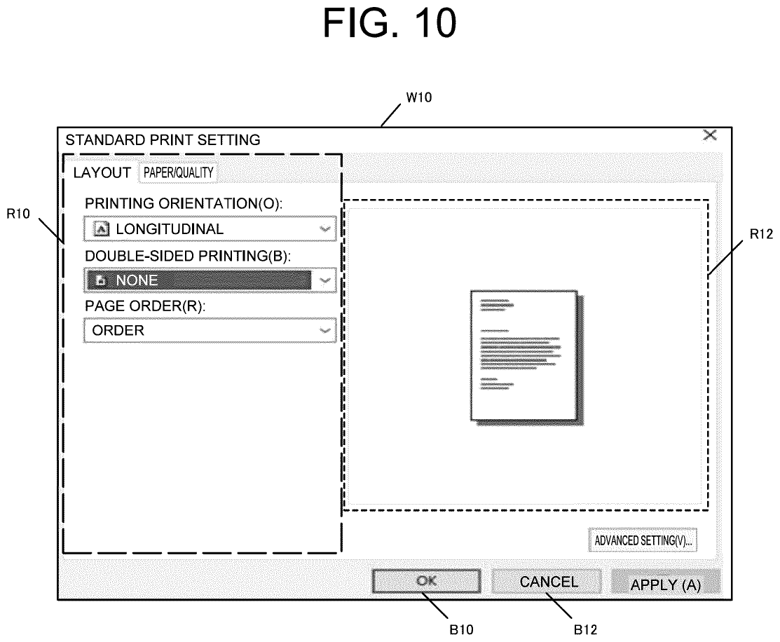

Next, an operation example according to the present embodiment will be explained. FIG. 10 is a diagram illustrating an example of a display configuration of the standard print setting screen. A standard print setting screen W10 is a print setting screen displayed by the controller 31 when it is determined that the standard printing is selected by a user in a print dialog of the application or the like.

The standard print setting screen W10 includes a print setting area R10, a preview display area R12, an OK button B10, and a cancel button B12.

The print setting area R10 is a display area for displaying print settings that can be set in standard printing. In the print setting area R10, a second attribute value defined in IPP Attributes is reflected. FIG. 10 illustrates an example in which printing orientation, double-sided printing, and page order are displayed as the second attribute values.

The preview display area R12 is a display area for displaying a preview of a print result in the standard printing. The user can grasp the print result in advance by checking a preview screen to be displayed in the preview display area R12.

The OK button B10 is a button for accepting an input of an instruction to execute standard printing. When an instruction to select the OK button is accepted from the user, the controller 31 starts the print job. The cancel button B12 is a button for accepting an input of an instruction to cancel the print setting via the standard print setting screen W10. When an instruction to select the cancel button B12 is accepted from the user, the controller 31 ends the processing related to the print job.

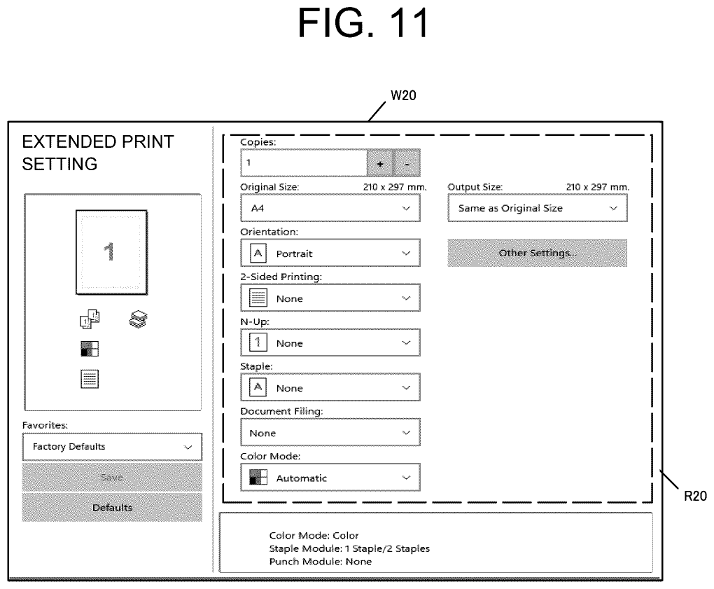

FIG. 11 is a diagram illustrating an example of a display configuration of the PSA extended print setting screen. A PSA extended print setting screen W20 is a print screen displayed by the controller 31 when it is determined that the accepted print instruction is not the print instruction related to standard printing, i.e., is a print instruction in a case where the print support program (PSA) is associated with the standard printer driver, in the print dialog or the like of the application.

The PSA extended print setting screen W20 includes a PSA extended print setting area R20. The PSA extended print setting area R20 is a display area for displaying print settings that can be set by the print support application. In the PSA extended print setting area R20, a first attribute value that is not defined in the IPP Attributes, i.e., a first attribute value related to the vendor-specific PJL is reflected. FIG. 11 is an example in which setting items such as “Copies”, “Original Size”, “Orientation”, “2-Sided Printing”, “N-Up”, “Staple”, “Document Filing”, “Color Mode”, and “Output Size” are displayed as examples of the extended print setting in the PSA extended print setting area R20.

In the PSA extended print setting screen W20, print setting specific to a vendor is extended and displayed as compared with the standard print setting screen W10 illustrated in FIG. 10. Thus, the user can fully utilize a capability of the multifunction peripheral 10 without installing the printer driver provided by the vendor.

As described above, in the present embodiment, when it is determined that “client-info>client-name:abcde” is included in IPP Attributes as the specific attribute information in the Validate-Job command and the Creat-Job command, the controller 11 performs a print setting, based on the vendor-specific PJL, and when it is determined that “client-info>client-name:abcde” is not included in IPP Attributes as the specific attribute information in the Validate-Job command and the Creat-Job command, the controller 11 performs a print setting, based on the IPP Attributes. Therefore, according to the present embodiment, in the print job related to a combination of the standard printer driver and the print support application, the capability of the printing apparatus to be targeted by the print support application can be correctly exhibited.

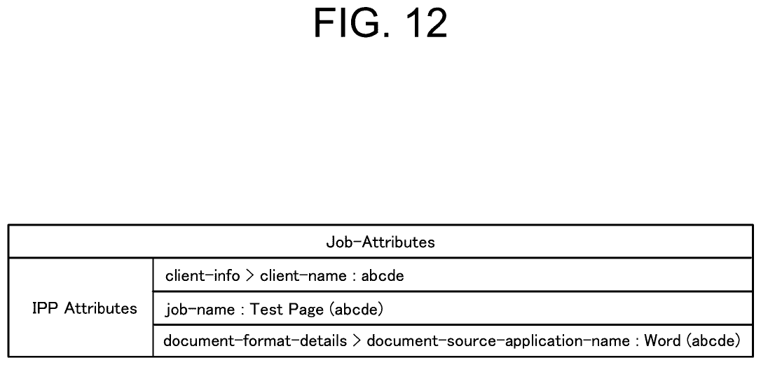

In FIG. 7, “client-info>client-name:abcde” has been explained as an example of the specific IPP Attributes. The specific IPP Attributes is not limited to “client-info>client-name:abcde”. As the specific IPP Attributes, for example, as illustrated in FIG. 12, it is also possible to use IPP Attributes such as “Job-name:TestPage (abcde)” and “document-format-details>document-source-application-name:Word (abcde)”.

The present disclosure is not limited to the above-described embodiments, and various modifications may be made. Namely, the embodiments to be acquired by combining techniques appropriately modified within the scope not departing from the gist of the present disclosure are also included in the technical scope of the present disclosure.

In addition, the above-described embodiments have parts that are explained separately for convenience of the explanation. However, it is needless to say that the embodiments may be combined and executed within a technically possible scope.

In addition, a program that operates in each apparatus in the embodiment is a program that controls a CPU or the like (a program that causes a computer to function) in a manner to achieve the functions of the above embodiment. Then, information to be handled by these apparatuses is temporarily stored in a temporary storage device (for example, RAM) at a time of processing the information, and then stored in various storage devices such as a Read Only Memory (ROM) and an HDD, and, as needed, is read, corrected, and written by the CPU.

Herein, the recording medium for storing a program may be any of a semiconductor medium (for example, a ROM, a non-volatile memory card, etc.), an optical recording medium/magneto-optical recording medium (for example, a digital versatile disc (DVD), a magneto optical disc (MO), a mini disc (MD), a compact disc (CD), and a Blu-ray (registered trademark) Disc (BD), and a magnetic recording medium (for example, magnetic tape, a flexible disk, etc.). In addition, not only the functions of the above-described embodiment are achieved by executing a loaded program, but also the functions of the present disclosure are achieved by processing in collaboration with the operating system, another application program, or the like, based on instructions of the program.

Further, in a case where the program is distributed in the market, the program can be stored in a portable recording medium and distributed, or transferred to a server computer connected via a network such as the Internet. In this case, a storage device of the server computer is also included in the present disclosure.

In addition, each functional block or various features of the apparatus used in the above-described embodiment can be implemented or executed by an electric circuit, for example, an integrated circuit or a plurality of integrated circuits. Electric circuit designed to achieve the functions described herein may include a general purpose processor, a digital signal processor (DSP), an application specific integrated circuit (ASIC), a field programmable gate array (FPGA), or other programmable logic device, discrete gate or transistor logic, discrete hardware components, or any combination thereof. A general-purpose processor may be a microprocessor, and the processor may be also any conventional processor, controller, microcontroller, or state machine. The above-described electric circuit may be configured by a digital circuit or an analog circuit. In addition, in a case where an integrated circuit technology that replaces the current integrated circuit has appeared due to the progress of the semiconductor technology, one or more aspects of the present disclosure can use a new integrated circuit according to the technology.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A printing apparatus comprising:
a printing section that is capable of printing a print job based on Internet Printing Protocol; and
a controller that performs a print setting by reflecting a first attribute value being not defined by the Internet Printing Protocol when it is determined that specific Internet Printing Protocol attribute information is included in the received print job,
performs a print setting by reflecting a second attribute value being defined by the Internet Printing Protocol when it is determined that the specific Internet Printing Protocol attribute information is not included in the received print job, and
controls the printing section, based on the set print setting.

2. The printing apparatus according to claim 1, wherein
the specific Internet Printing Protocol attribute information is attribute information indicating that the print job is a print job being output via a print support application, and
the controller performs the print setting by reflecting the first attribute value being assigned via the print support application when it is determined that the specific Internet Printing Protocol attribute information is included in the received print job.

3. The printing apparatus according to claim 2, wherein
the controller performs the print setting by reflecting the first attribute value described in a printer job language.

4. A printing method of a print job based on Internet Printing Protocol, the printing method comprising:
performing a print setting by reflecting a first attribute value being not defined by the Internet Printing Protocol when it is determined that specific Internet Printing Protocol attribute information is included in the received print job;
performing a print setting by reflecting a second attribute value being defined by the Internet Printing Protocol when it is determined that the specific Internet Printing Protocol attribute information is not included in the received print job; and
executing the print job, based on the set print setting.

5. An information processing apparatus comprising:
a storage that stores a control program and a print support program; and
a controller that is capable of generating a print job based on Internet Printing Protocol by executing the control program, wherein
the controller functions as a print support application by executing the print support program, and
the print support application assigns specific Internet Printing Protocol attribute information indicating that the print job is a print job to be output via the print support application.
